(19) United States
(12) Patent Application Publication
(10) Pub. No.: US 2020/0072681 A1
(43) Pub. Date: Mar. 5, 2020

(54) TEMPERATURE MEASUREMENT APPARATUS, TEMPERATURE MEASUREMENT METHOD, AND STORAGE MEDIUM

(71) Applicant: FUJITSU LIMITED, Kawasaki-shi (JP)

(72) Inventors: Takahiro Arioka, Isehara (JP); Kazushi Uno, Atsugi (JP); Takeo Kasajima, Machida (JP)

(73) Assignee: FUJITSU LIMITED, Kawasaki-shi (JP)

(21) Appl. No.: 16/677,742

(22) Filed: Nov. 8, 2019

Related U.S. Application Data
(63) Continuation of application No. PCT/JP2017/018566, filed on May 17, 2017.

(51) Int. Cl. G01K 11/32

(52) U.S. Cl. CPC G01K 11/32

(57) ABSTRACT

A temperature measurement apparatus includes an optical fiber disposed along a predetermined path, the optical fiber having two sections provided in front of and behind a predetermined section, the two sections allowing acquisition of respective identical temperature distributions; a light source configured to cause light to enter into the optical fiber; and a processor coupled to the light source and configured to: measure a temperature distribution in an extension direction of the optical fiber, based on backward scattered light from the optical fiber, and correct the measured temperature distribution in the predetermined section, by using a Stokes component and an anti-Stokes component contained in the backward scattered light in each of the two sections.

### CROSS-REFERENCE TO RELATED APPLICATION

This application is a continuation application of International Application PCT/JP2017/018566 filed on May 17, 2017 and designated the U.S., the entire contents of which are incorporated herein by reference.

### FIELD

The present invention relates to a temperature measurement apparatus, a temperature measurement method, and a storage medium.

### BACKGROUND

There has been developed a technique of measuring a temperature distribution in the extension direction of an optical fiber, with Stokes light and anti-Stokes light contained in backward scattered light from the optical fiber after light has entered the optical fiber from a light source (see, for example, Patent Documents 1 and 2).

Patent Document 1: Japanese Laid-open Patent Publication No. 07-218354

Patent Document 2: Japanese Laid-open Patent Publication No. 2014-167399

Backward scattered light is attenuated due to factors such as degradation of an optical fiber. A difference in the attenuation ratio between Stokes light and anti-Stokes light causes an error in temperature measurement. In consideration of such circumstances, it is desirable to be capable of providing a temperature measurement apparatus, a temperature measurement method, and a temperature measurement program capable of correcting an error in temperature measurement.

### SUMMARY

According to an aspect of the embodiments, a temperature measurement apparatus includes an optical fiber disposed along a predetermined path, the optical fiber having two sections provided in front of and behind a predetermined section, the two sections allowing acquisition of respective identical temperature distributions; a light source configured to cause light to enter into the optical fiber; and a processor coupled to the light source and configured to: measure a temperature distribution in an extension direction of the optical fiber, based on backward scattered light from the optical fiber, and correct the measured temperature distribution in the predetermined section, by using a Stokes component and an anti-Stokes component contained in the backward scattered light in each of the two sections.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a schematic view of the general arrangement of a temperature measurement apparatus according to an embodiment;

FIG. 1B is a block diagram for describing a hardware configuration of a control unit;

FIG. 2 is a graph illustrating components of backward scattered light;

FIG. 3A is a graph exemplarily illustrating the relationship between elapsed time after light pulse emission by a laser and the respective light intensities of a Stokes component and an anti-Stokes component;

FIG. 3B illustrates temperature calculated with a detection result of FIG. 3A;

FIGS. 4A to 4C are exemplary graphs and table of measured temperatures at respective locations in an optical fiber within a relatively short distance range;

FIG. 5A is an exemplary graph of the respective light intensities of the Stokes component and the anti-Stokes component before and after degradation of the optical fiber;

FIG. 5B is an exemplary graph of the result of temperature measurement for sections identical in temperature distribution before and after the degradation of the optical fiber;

FIG. 6 is an exemplary illustration of constant temperature sections;

FIGS. 7A to 7F are exemplary graphs of correction processing;

FIGS. 8A to 8D are exemplary graphs of simulation results of the correction processing;

FIGS. 9A to 9C are exemplary graphs of the simulation results of the correction processing;

FIG. 10 is a flowchart illustrating an example of temperature-correction processing by the temperature measurement apparatus;

FIG. 11 is an exemplary graph of the temperature dependency of the respective light intensities of the Stokes light and the anti-Stokes light;

FIGS. 12A and 12B are illustration and graph of another installation example of the optical fiber;

FIGS. 13A and 13B are illustration and graph of yet another installation example of the optical fiber; and

FIG. 14 is an exemplary illustration of a temperature measurement system.

### DESCRIPTION OF EMBODIMENTS

Hereinafter, an embodiment will be described with reference to the drawings.

### Embodiment

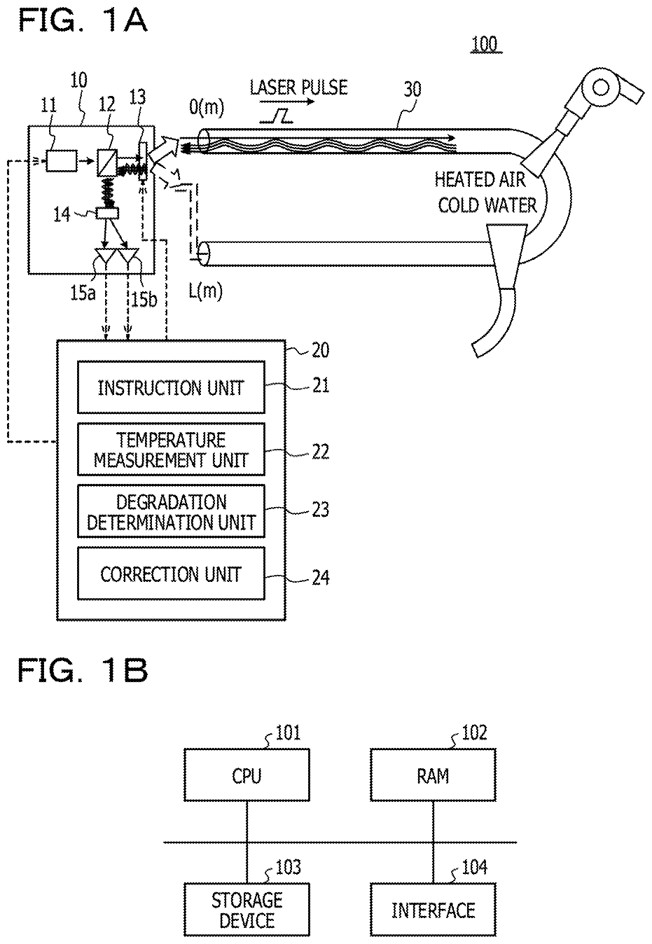

FIG. 1A is a schematic view of the general arrangement of a temperature measurement apparatus 100 according to an embodiment. As exemplarily illustrated in FIG. 1A, the temperature measurement apparatus 100 includes, for example, a measurement device 10, a control unit 20, and an optical fiber 30. The measurement device 10 includes, for example, a laser 11, a beam splitter 12, an optical switch 13, a filter 14, a plurality of detectors 15a and 15b. The control unit 20 includes, for example, an instruction unit 21, a temperature measurement unit 22, a degradation determination unit 23, and a correction unit 24.

FIG. 1B is a block diagram for describing a hardware configuration of the control unit 20. As exemplarily illustrated in FIG. 1B, the control unit 20 includes, for example, a CPU 101, a RAM 102, a storage device 103, and an interface 104. Each of these devices is connected via, for example, a bus. The central processing unit (CPU) 101 serves as a central processing unit. The CPU 101 includes one or more cores. The random access memory (RAM) 102 serves as a volatile memory that temporarily stores a program to be executed by the CPU 101, data to be processed by the CPU 101, and the like. The storage device 103 serves as a non-volatile storage device. Examples of the storage device 103 that can be used include a read only memory (ROM), a solid state drive (SSD) such as a flash memory, or a hard disk driven by a hard disk drive. Execution, by the CPU 101, of a temperature measurement program stored in the storage device 103 allows the control unit 20 to function as the instruction unit 21, the temperature measurement unit 22, the degradation determination unit 23, and the correction unit 24. Note that the instruction unit 21, the temperature measurement unit 22, the degradation determination unit 23, and the correction unit 24 may be hardware such as a dedicated circuit.

The laser 11 serves as a light source such as a semiconductor laser, and emits laser beams in a predetermined wavelength range following an instruction of the instruction unit 21. In the present embodiment, the laser 11 emits light pulses (laser pulses) at predetermined time intervals. The beam splitter 12 causes the light pulses emitted from the laser 11 to enter the optical switch 13. The optical switch 13 serves as a switch that switches an emission destination (channel) of the light pulses having entered. In a double-end scheme to be described later, the optical switch 13 causes the light pulses alternately to enter a first end and a second end of the optical fiber 30 at constant cycles following an instruction of the instruction unit 21. In a single-end scheme to be described later, the optical switch 13 causes the light pulses to enter either the first end or the second end of the optical fiber 30 following an instruction of the instruction unit 21. The optical fiber 30 is disposed along a predetermined path to be measured in temperature. In the present embodiment, it is assumed that: the optical fiber 30 has a length of L meters (m); the first end is located at 0 meter (m); and the second end is located at L meters (m).

The light pulses having entered in the optical fiber 30 propagates in the optical fiber 30. The light pulses are gradually attenuated and propagates in the optical fiber 30 while generating forward scattered light traveling in the propagation direction of the light pulses and backward scattered light (return light) traveling in the feedback direction of light pulses. The backward scattered light passes through the optical switch 13 and re-enters the beam splitter 12. The backward scattered light having entered the beam splitter 12 is emitted to the filter 14. The filter 14 serves as a WDM coupler or the like, and extracts the backward scattered light into a long-wavelength component (Stokes component to be described later) and a short-wavelength component (anti-Stokes component to be described later). The detectors 15a and 15b serve as photoreceptors. The detector 15a converts the received light intensity of the short-wavelength component in the backward scattered light into an electric signal and transmits the electric signal to the temperature measurement unit 22. The detector 15b converts the received light intensity of the long-wavelength component in the backward scattered light into an electric signal and transmits the electric signal to the temperature measurement unit 22. The temperature measurement unit 22 measures the temperature distribution in the extension direction of the optical fiber 30, with the Stokes component and the anti-Stokes component. The degradation determination unit 23 determine whether the optical fiber 30 is degraded, with the Stokes component and the anti-Stokes component. In a case where the degradation determination unit 23 determines that the optical fiber 30 is degraded, the correction unit 24 corrects the temperature distribution acquired by the temperature measurement unit 22.

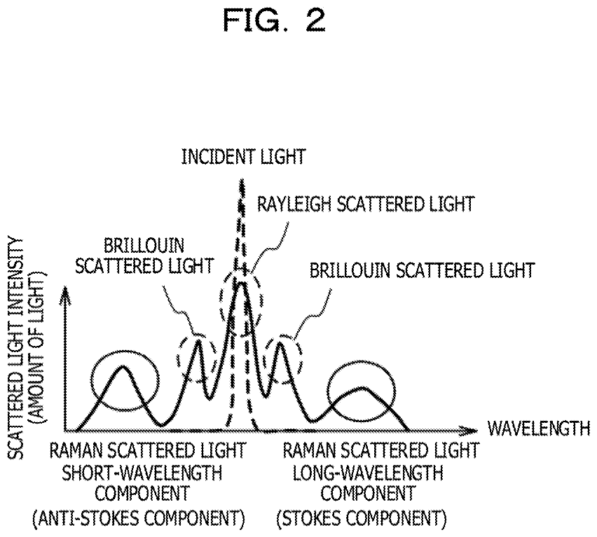

FIG. 2 is a graph illustrating components of the backward scattered light. As exemplarily illustrated in FIG. 2, the backward scattered light is broadly classified into three types. These three types of light are, in order of highest light intensity and in the order of closest to the incident light wavelength: Rayleigh scattered light to be used for an OTDR (optical pulse tester) or the like; Brillouin scattered light to be used in strain measurement or the like; and Raman scattered light to be used in temperature measurement or the like. The Raman scattered light is generated due to the interference between lattice vibration that varies in accordance with temperature and light in the optical fiber 30. The constructive interference generates the short-wavelength component called the anti-Stokes component, and the destructive interference generates the long-wavelength component called the Stokes component.

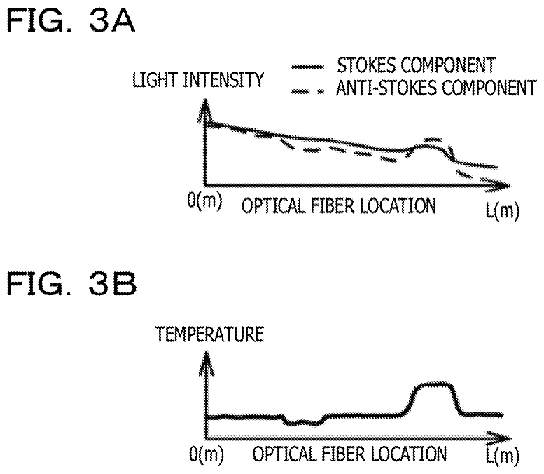

FIG. 3A is a graph exemplarily illustrating the relationship between elapsed time after light pulse emission by the laser 11 and the respective light intensities of the Stokes component (long-wavelength component) and the anti-Stokes component (short-wavelength component), in a case where light has entered from the first end of the optical fiber 30. The elapsed time corresponds to a propagation distance in the optical fiber 30 (location in the optical fiber 30). As exemplarily illustrated in FIG. 3A, the respective light intensities of the Stokes component and the anti-Stokes component both decrease with the elapsed time. This decrease results from the gradual attenuation and propagation of the light pulses in the optical fiber 30 while the light pulse generates the forward scattered light and the backward scattered light.

As exemplarily illustrated in FIG. 3A, the light intensity of the anti-Stokes component is higher at a location where the temperature is high in the optical fiber 30 than the light intensity of the Stokes component. On the other hand, the light intensity of the anti-Stokes component is lower at a location where the temperature is low in the optical fiber 30 than the light intensity of the Stokes component. Thus, detection of both components with the detectors 15a and 15b and use of the characteristic difference between both of the components enable detection of temperature at each location in the optical fiber 30. Note that in FIG. 3A, the region indicating the maximum is a region where the optical fiber 30 is intentionally heated with a dryer or the like in FIG. 1A. In contrast, the region indicating the minimum is a region where the optical fiber 30 is intentionally cooled with cold water or the like in FIG. 1A.

In the present embodiment, the temperature measurement unit 22 measures the temperature from the Stokes component and the anti-Stokes component every elapsed time. As a result, the temperature at each location in the optical fiber 30 can be measured. That is, the temperature distribution in the extension direction of the optical fiber 30 can be measured. Note that due to the use of the characteristic difference between both components, even if the respective light intensities of both of the components are attenuated in accordance with the distance of the optical fiber 30, the temperature can be measured with high accuracy. FIG. 3B illustrates the temperature calculated with the detection result of FIG. 3A. The horizontal axis in FIG. 3B represents the location in the optical fiber 30 calculated on the basis of the elapsed time. As exemplarily illustrated in FIG. 3B, the detection of the Stokes component and the anti-Stokes component enables the temperature measurement at each location in the optical fiber 30.

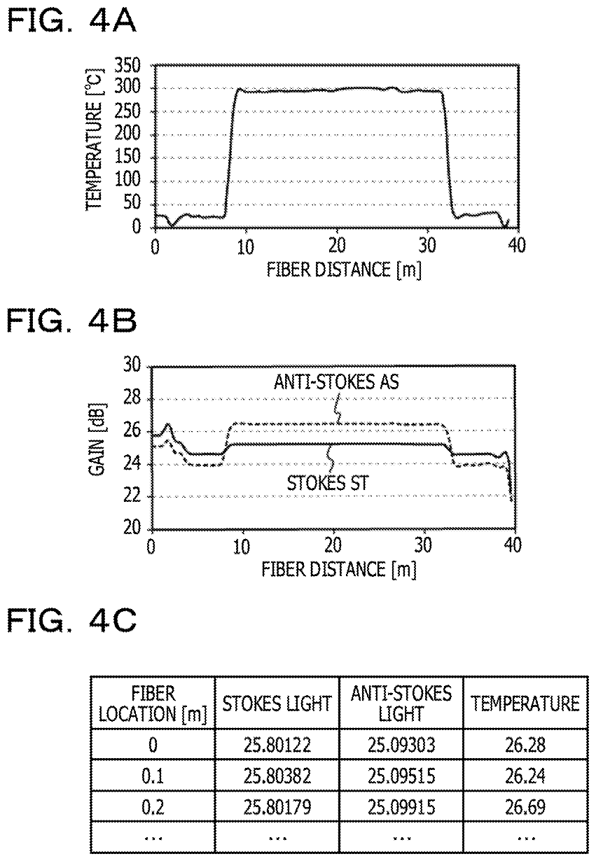

FIGS. 4A to 4C are exemplary graphs and table of measured temperatures at respective locations in the optical fiber 30 within a relatively short distance range. First, as exemplarily illustrated in FIG. 4B, the temperature measurement unit 22 acquires the Stokes component and the anti-Stokes component at a predetermined sampling cycle (for each predetermined distance). In the example of FIG. 4C, the Stokes component and the anti-Stokes component are acquired every 0.1 m. Next, the temperature measurement unit 22 calculates the temperature at each sampling point, from the acquired Stokes component and anti-Stokes component. FIG. 4A illustrates, as a graph, the measured temperature at each sampling point.

A scheme in which the incident position from the optical switch 13 to the optical fiber 30 is fixed at the first end or the second end is called, for example, “one-end scheme” or “single-end scheme” (hereinafter referred to as single-end scheme). The single-end scheme is advantageous in term of simplifying temperature measurement processing, due to elimination of the need for switching the incident position. On the other hand, noise increases with distance from the incident position.

In contrast, a scheme of switching the incident position between the first end and the second end at constant cycles is called, for example, “loop measurement”, “double-end measurement”, or “dual-end measurement” (hereinafter referred to as double-end scheme). In the double-end scheme, averaging (calculating an average value of), before and after switching, the respective amounts of the anti-Stokes light and the amount of the Stokes light at each location in the optical fiber 30 enables the temperature measurement. This scheme is advantageous in term of noise reduction at an end portion of the optical fiber 30, whereas requiring control such as the switching of the incident position. For example, the temperature resolution is improved four times or more than the temperature resolution with the single-end scheme.

In addition, occurrence of excessive bending in the path causes transmission loss, which results in an abrupt drop in the light intensity at the point. In this case, due to the abrupt drop in the light intensity, the ratio of the Stokes component to the anti-Stokes component varies, so that the temperature measurement accuracy decreases. The double-end scheme, however, provides an advantage in that the averaging can cancel abrupt variation in front of and behind a bending loss point, that is, the averaging can eliminate variation loss in the length direction of the optical fiber 30.

The intensive studies by the present inventors have found that an error occurs in temperature measurement even with the double-end scheme. Hereinafter, the reason for the error occurrence in temperature measurement will be described.

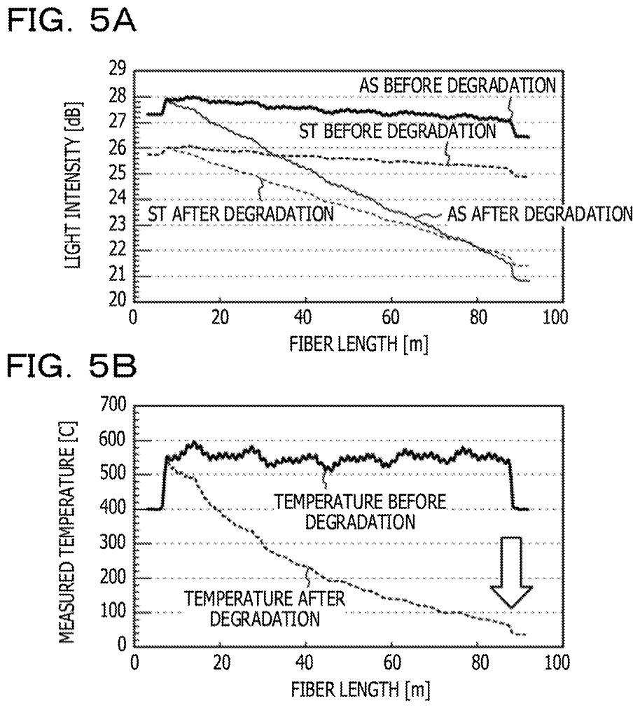

The backward scattered light is attenuated due to degradation of the optical fiber 30. The degradation of the optical fiber 30 means that secular change of the optical fiber 30, and more specifically, occurrence of, for example, light leakage or light absorption. FIG. 5A is an exemplary graph of the respective light intensities of the Stokes component (ST) and the anti-Stokes component (AS) before and after the degradation of the optical fiber 30 at the same temperature distribution. With no occurrence of degradation of the optical fiber 30, an error in temperature measurement with the optical fiber 30 is small, so that the measured temperature may not be corrected.

As exemplarily illustrated in FIG. 5A, the Stokes component and the anti-Stokes component both have a drop in light intensity after the degradation as compared to before the degradation. The attenuation ratio of the anti-Stokes component to light propagation distance, however, is larger than the attenuation ratio of the Stokes component to light propagation distance. That is, the anti-Stokes component is greatly attenuated to the light propagation distance. As described above, the attenuation ratio of the Stokes light and the attenuation ratio of the anti-Stokes light are different from each other, so that an error occurs in temperature measurement. FIG. 5B is an exemplary graph of the result of temperature measurement for sections identical in temperature distribution before and after the degradation of the optical fiber. As exemplarily illustrated in FIG. 5B, the measured temperature significantly lowers after the degradation as compared to before the degradation. As described above, an error occurs in temperature measurement.

Therefore, it is conceivable to correct the difference in attenuation ratio, with, for example, a reference temperature, or attenuation of Rayleigh scattering. However, there are required, for example, new installation of a thermometer and a temperature adjustment device, and additional installation of a detector. In addition, attenuation non-linear to distance is difficult to be corrected. Therefore, in the present embodiment, a constant temperature section is provided in front of and behind a section where attenuation occurs, and a measured temperature is corrected with the difference in amount between the Stokes component and the anti-Stokes component in each of the constant temperature sections to correct an error in the measured temperature.

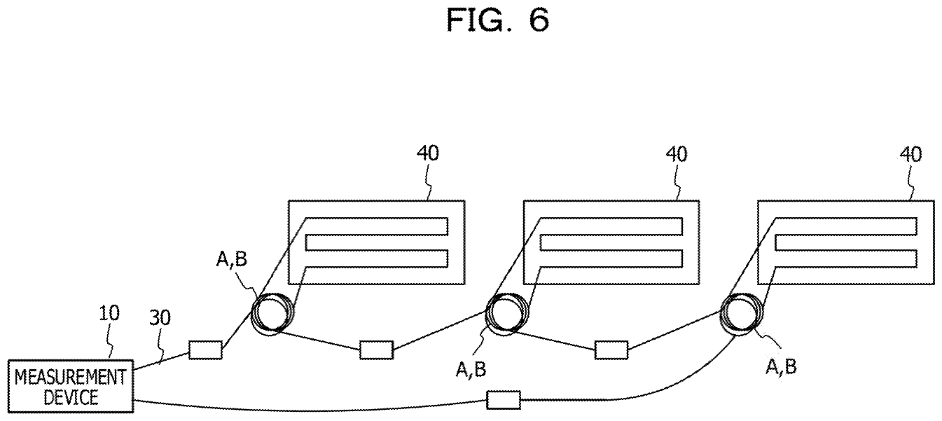

As exemplarily illustrated in FIG. 6, constant temperature sections A and B are provided with, for example, a would portion or a termination cable, in front of and behind a section having a factor of degrading the optical fiber 30, such as a high-temperature body 40. In the present embodiment, the constant temperature section A and the constant temperature section B are installed at the same location in front of and behind a section installed along the high-temperature body 40. That is, the constant temperature section A and the constant temperature section B means sections different in location in the extension direction of the optical fiber 30 but identical in installation location. For example, the optical fiber 30 is overlapped and wound in the constant temperature section A and the constant temperature section B. The respective installation sites of the constant temperature sections A and B are lower in temperature than the high-temperature body 40. The constant temperature section A is located closer to the light incident side than the constant temperature section B. In a closed space such as a chamber having a constant temperature, if the constant temperature sections A and B are located in front of and behind a section to be measured, no wound portion or the like may be provided. In addition, there may be provided, in one loop, two or more sections where degradation is corrected. In the example of FIG. 6, three pairs of the constant temperature sections are provided.

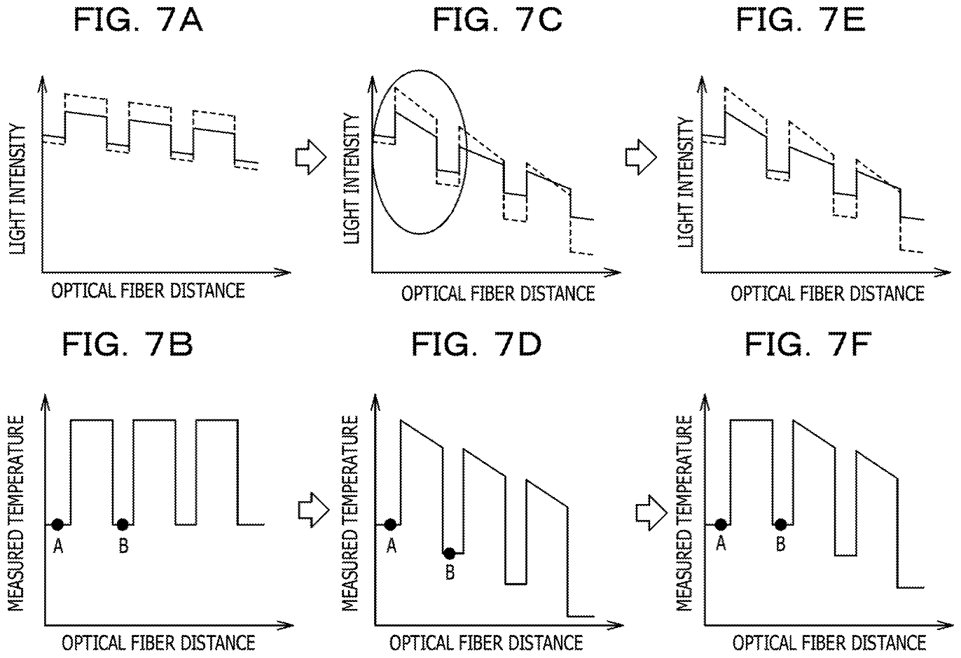

With no occurrence of degradation the optical fiber 30, the respective attenuation ratios of the Stokes component and the anti-Stokes component to distance are equal as exemplarily illustrated in FIG. 7A. In FIG. 7A, the solid line represents the Stokes component, and the dotted line represents the anti-Stokes component. The representation shall be applied to the representation in FIGS. 7C and 7E. As exemplarily illustrated in FIG. 7B, the same temperature is measured in the constant temperature section A and the constant temperature section B.

Here, for the constant temperature section A, the average Stokes light intensity is defined as STA, and the average anti-Stokes light intensity is defined as ASA. For the constant temperature section B, the average Stokes light intensity is defined as STB, and the average anti-Stokes light intensity is defined as ASB. In this case, with no occurrence of degradation of the optical fiber 30, Expression (1) below is satisfied.

STA−ASA=STB−ASB (1)

In occurrence of attenuation due to degradation of the optical fiber 30, as exemplarily illustrated in FIG. 7C, the anti-Stokes component in the constant temperature section B is attenuated more than the anti-Stokes component in the constant temperature section A. In this case, Expression (1) above is unsatisfied, and Expression (1) above transforms as Expression (2) below. In this case, as exemplarily illustrated in FIG. 7D, a difference occurs in measured temperature between the constant temperature section A and the constant temperature section B between which the same temperature is measured normally.

STA−ASA=STB−ASB−α (2)

Therefore, the correction unit 24 corrects the anti-Stokes component to correct the measured temperature. First, there can be represented, as Expression (3) below, AS′(x) after linear correction for the light intensity AS(x) of the anti-Stokes component at a location x between the constant temperature section A and the constant temperature section B. There can be represented, as Expression (4) below, AS′(x) after linear correction for the light intensity AS(x) of the anti-Stokes component at a location x after the constant temperature section B. Note that, A and B in Expressions (3) and (4) respectively represent the locations of the constant temperature section A and the constant temperature section B in the optical fiber 30. The representation shall be applied hereinafter.

AS′(x)=AS(x)+α(x−A)/(B−A) (3)

AS′(x)=AS(x)+α (4)

A linear variation in the amount of attenuation to distance in a degraded section can be solved with the above method. However, exposure environment such as temperature or atmosphere is different for each distance of the optical fiber 30; thus, the variation in the amount of attenuation is basically non-linear to the distance. In order to obtain a non-linear attenuation component, first, the normalized Stokes component st(x) at the location x between the constant temperature section A and the constant temperature section B is defined as: st(x)=ST(x)−STA+(x−A)/(STA−STB)/(B−A); and the anti-Stokes component as(x) is defined as: as(x)=AS(x)−ASA+(x−A)(ASA−ASB)/(B−A). When a point x1 is defined as the initial location with no attenuation after the constant temperature section A, and the ratio β of the as to the st is defined as β=as(x1)/st(x1), ’st(x)−as(x) is proportional to an error component due to the non-linear attenuation ratio to be corrected. Therefore, AS″(x) after non-linear correction can be represented as AS″(x)=AS′(x)+γ(βst(x)−as(x)). γ represents a constant related to the light intensity at measurement, and if a place known in temperature, or a place spatially close to and equal in temperature to the location x1 is located in a degraded section, the place can be obtained by, as below, Relational Expression (5) between the temperature, the ST, and the AS.

AS/ST={(ω₀+ωₖ)/(ω₀−ωₖ)}⁴exp(−ωₖ/2nkT) (5)

Here, it is assumed that the angular frequency of the incident light is ω₀; the angular frequency of the optical phonon in the optical fiber is ωₖ; the Planck constant is h; the Boltzmann constant is k; and the temperature is T.

According to the above correction processing, even in occurrence of a discrepancy in attenuation ratio between the Stokes component and the anti-Stokes component such as illustrated in FIG. 7E, the respective measured temperatures in the constant temperature sections A and B are corrected so as to be equal as exemplarily illustrated in FIG. 7F.

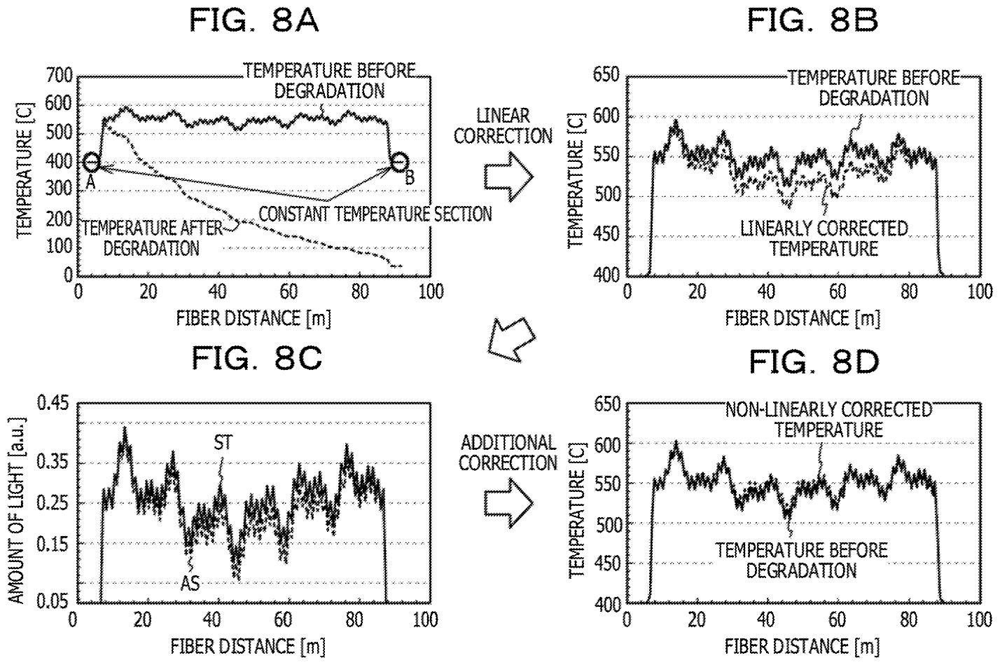

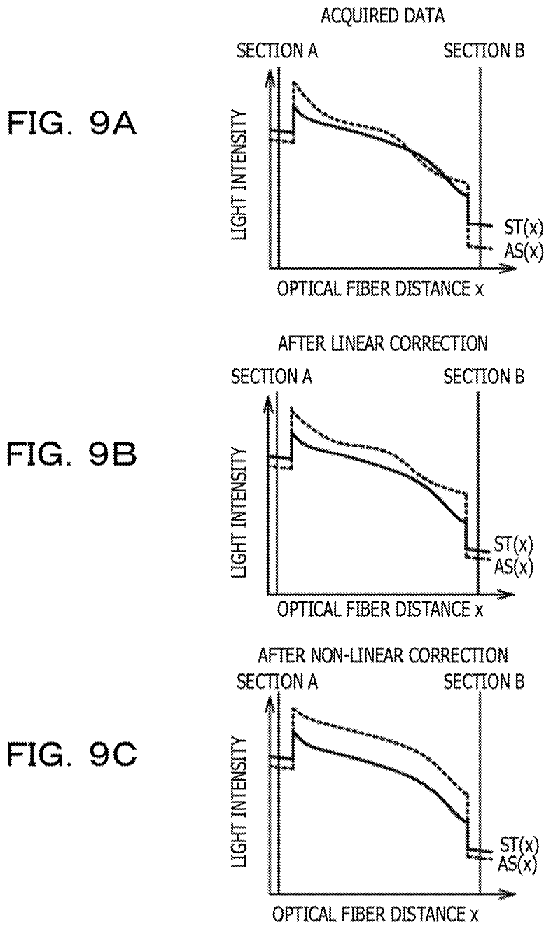

FIGS. 8A to 8D and FIGS. 9A to 9C exemplary graphs of simulation results of the correction processing. FIGS. 8A to 8D exemplify the measured temperatures, and FIGS. 9A to 9C exemplify the Stokes component and the anti-Stokes component.

As exemplarily illustrated in FIG. 8A, before occurrence of degradation of the optical fiber 30, the measured temperature is high at the high-temperature body, and the measured temperatures are equal in the constant temperature sections A and B. FIG. 9A exemplarily illustrates the Stokes component ST(x) and the anti-Stokes component AS(x) with occurrence of degradation of the optical fiber 30. As exemplarily illustrated in FIG. 9A, a discrepancy occurs in attenuation ratio between the Stokes component and the anti-Stokes component. In this case, the measured temperature is as indicated by a dotted line in FIG. 8A. That is, there may occur a difference in measured temperature between the constant temperature section A and the constant temperature section B.

Therefore, linear correction is performed for the anti-Stokes component. The result is exemplarily illustrated in FIG. 9B. In this case, the measured temperatures are as exemplarily illustrated in FIG. 8B. As compared to the case of FIG. 8A, the difference between the corrected measured temperature and the measured temperature before the degradation is smaller. In contrast, a difference occurs between the corrected measured temperature and the measured temperature before the degradation. FIG. 8C exemplarily illustrates the Stokes component and the anti-Stokes component after the linear correction. The difference between the Stokes component and the anti-Stokes component after the linear correction is proportional to the non-linear attenuation component.

Therefore, non-linear correction is performed for the anti-Stokes component. The result is exemplarily illustrated in FIG. 9C. In this case, the measured temperature is as exemplarily illustrated in FIG. 8D. As compared to the case of FIG. 8B, the difference between the corrected measured temperature and the measured temperature before the degradation is further smaller.

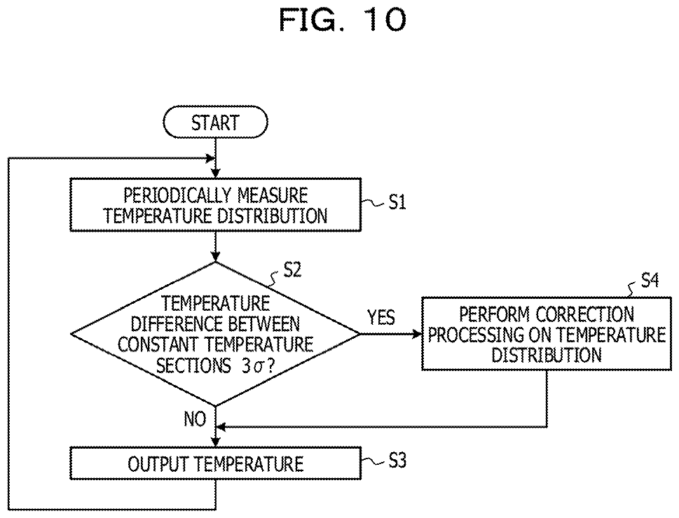

FIG. 10 is a flowchart illustrating an example of the temperature-correction processing by the temperature measurement apparatus 100. As exemplarily illustrated in FIG. 10, the temperature measurement unit 22 periodically acquires the Stokes component and the anti-Stokes component to measure the temperature distribution in the optical fiber 30 (step S1). Next, the degradation determination unit 23 determines whether the temperature difference between the constant temperature section A and the constant temperature section B exceeds 3σ (step S2). Note that a represents a standard deviation and can be calculated in advance from variation in the measured temperatures for repetition of measurement at a constant temperature.

In a case where it is determined as “No” in step S2, the temperature measurement unit 22 outputs the measured temperature distribution without correcting the measured temperature distribution (step S3). In a case where it is determined as “Yes” in step S2, the correction unit 24 performs the linear correction and the non-linear correction for the measured temperature distribution, with the above described correction method (step S4). After that, step S3 is performed. In this case, the corrected temperature distribution is output.

According to the present embodiment, the temperature distribution measured by the temperature measurement unit 22 is corrected with the Stokes component and the anti-Stokes component of each of the constant temperature sections A and B. This arrangement enables correction of an error in temperature measurement without new installation of a thermometer or a temperature adjustment device, and additional installation of a detector.

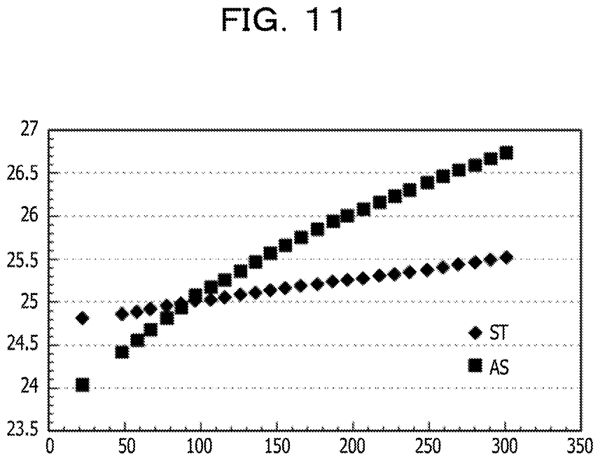

As exemplarily illustrated in FIG. 11, the difference in light intensity between the Stokes light and the anti-Stokes light is smallest at around 90° C., for example, for incident light near 1000 nm. In order to improve the accuracy of correction under the conditions for the constant temperature sections, a large difference is advantageous; thus, it is preferable to select, for the temperature for the constant temperature sections, about 300° C. to 400° C. between which no degradation occurs and the difference in light intensity is large.

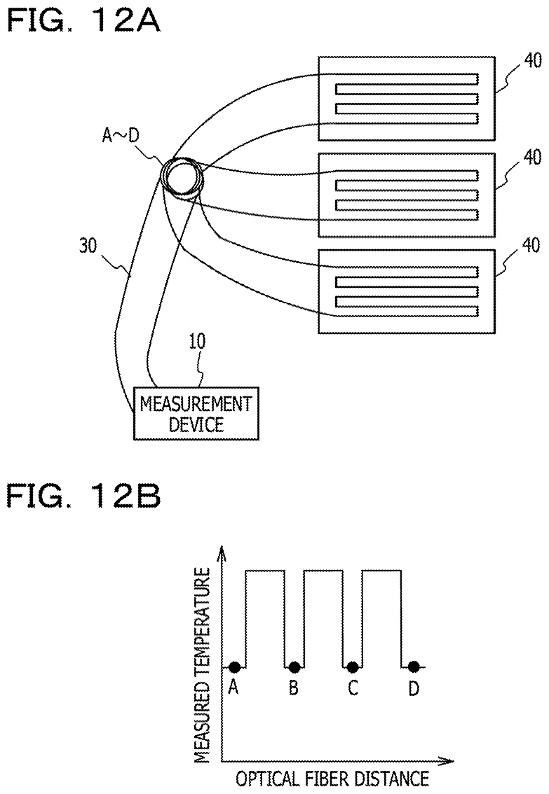

FIGS. 12A and 12B are illustration and graph of another installation example of the optical fiber 30. As exemplarily illustrated in FIGS. 12A and 12B, constant temperature sections A to D installed at a common location may be provided to a plurality of high-temperature bodies 40. For example, for adjacent high-temperature bodies 40, one constant temperature section is shared and used. In the example of FIG. 12A, the four constant temperature sections A to D can be used for the three high-temperature bodies 40.

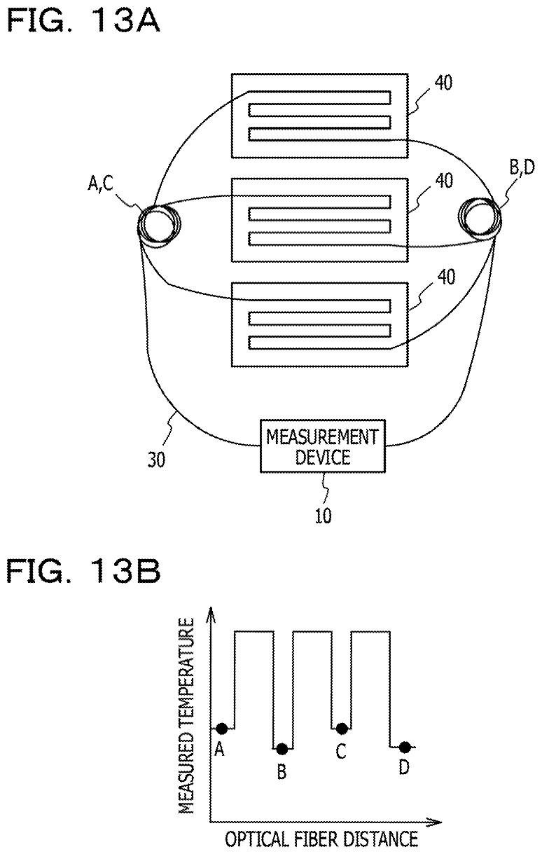

FIGS. 13A and 13B are illustration and graph of yet another installation example of the optical fiber 30. As exemplarily illustrated in FIGS. 13A and 13B, constant temperature sections A and C of a first type and constant temperature sections B and D of a second type may be provided. Even in this case, correction processing can be performed with the constant temperature sections A and C or the constant temperature sections B and D, the constant temperature sections A to D different in distance.

(Another Example)

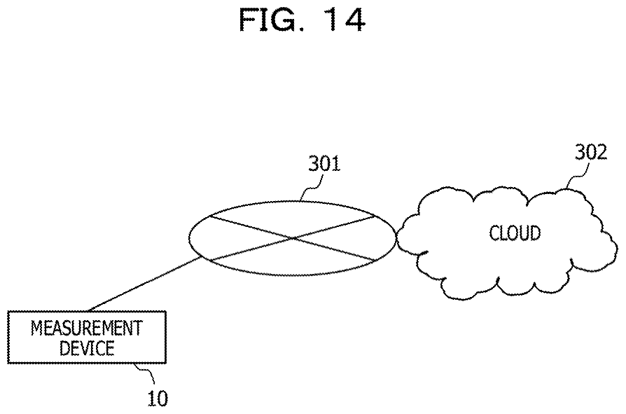

FIG. 14 is an exemplary illustration of a temperature measurement system. As exemplarily illustrated in FIG. 14, the temperature measurement system has a configuration in which a measurement device 10 is connected to a cloud 302 through a telecommunication line 301 such as the Internet. The cloud 302 includes, for example, a CPU 101, a RAM 102, a storage device 103, an interface 104, such as in FIG. 1B, and provides a function as a control unit 20. For such a temperature measurement system, for example, measurement results measured at a foreign power plant are received by the cloud 302 installed in Japan, and a temperature distribution is measured. Note that instead of the cloud 302, a server connected via an intranet or the like may be used.

In each of the examples described above, the optical fiber 30 is an example of an optical fiber disposed along the predetermined path, the optical fiber having the two sections provided in front of and behind the predetermined section, the two sections allowing acquisition of the respective identical temperature distributions. The temperature measurement unit 22 is an example of a temperature measurement unit that measures the temperature distribution in the extension direction of the optical fiber on the basis of the backward scattered light from the optical fiber. The correction unit 24 is an example of a correction unit that corrects the temperature distribution in the predetermined section measured by the temperature measurement unit, with the Stokes component and the anti-Stokes component contained in the backward scattered light in each of the two sections. The degradation determination unit 23 is an example of a determination unit that determines whether the temperature difference between the two sections by the temperature measurement unit is a threshold or greater.

The embodiment of the present invention has been described in detail; however, the present invention is not limited to such a specific embodiment, and various modifications and alterations can be made within the scope of gist of the present invention described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A temperature measurement apparatus comprising:
an optical fiber disposed along a predetermined path, the optical fiber having two sections provided in front of and behind a predetermined section, the two sections allowing acquisition of respective identical temperature distributions;
a light source configured to cause light to enter into the optical fiber; and
a processor coupled to the light source and configured to:
measure a temperature distribution in an extension direction of the optical fiber, based on backward scattered light from the optical fiber, and
correct the measured temperature distribution in the predetermined section, by using a Stokes component and an anti-Stokes component contained in the backward scattered light in each of the two sections.

2. The temperature measurement apparatus according to claim 1, wherein the processor is configured to:
determine whether a temperature difference between the two sections is equal to or more than a threshold, and
when it is determined that the temperature difference is equal to or more than the threshold, correct the temperature distribution in the predetermined section.

3. The temperature measurement apparatus according to claim 1,
wherein the predetermined section is disposed in a section higher in temperature than the two sections.

4. The temperature measurement apparatus according to claim 1, wherein the processor is configured to
perform linear correction to distance in the optical fiber, for the anti-Stokes component in the predetermined section to correct the temperature distribution in the predetermined section.

5. The temperature measurement apparatus according to claim 4, wherein the processor is configured to:
assume that a difference in amount between the Stokes component and the anti-Stokes component in the predetermined section increases linearly in accordance with the distance in the optical fiber, and
perform the linear correction such that linear variation of the difference in amount is canceled.

6. The temperature measurement apparatus according to claim 4, wherein the processor is configured to
correct the temperature distribution in the predetermined section, with a difference in amount between the Stokes component in the predetermined section and the anti-Stokes component after the linear correction.

7. The temperature measurement apparatus according to claim 6,
wherein the processor is configured to correct, by using the difference in amount between the Stokes component in the predetermined section and the anti-Stokes component after the linear correction, the temperature distribution in the predetermined section such that non-linear attenuation of the anti-Stokes component to the Stokes component is canceled.

8. The temperature measurement apparatus according to claim 1,
wherein the two sections are respectively disposed at a site allowing acquisition of a temperature distribution of 300° C. to 400° C.

9. A temperature measurement method executed by a temperature measurement apparatus, the method comprising:
causing, by a light source, light to enter into an optical fiber disposed along a predetermined path, the optical fiber having two sections provided in front of and behind a predetermined section, the two sections allowing acquisition of respective identical temperature distributions;
causing a processor to measure a temperature distribution in an extension direction of the optical fiber, based on backward scattered light from the optical fiber; and
causing the processor to correct the measured temperature distribution in the predetermined section, by using a Stokes component and an anti-Stokes component contained in the backward scattered light in each of the two sections.

10. A non-transitory computer-readable storage medium storing a temperature measurement program that causes a computer to execute a process, the process comprising:
measuring a temperature distribution in an extension direction of an optical fiber disposed along a predetermined path based on backward scattered light from the optical fiber into which light has entered from a light source, the optical fiber having two sections provided in front of and behind a predetermined section, the two sections allowing acquisition of respective identical temperature distributions; and
correcting the measured temperature distribution in the predetermined section, by using a Stokes component and an anti-Stokes component contained in the backward scattered light in each of the two sections.
